(19) United States
(12) Patent Application Publication
(10) Pub. No.: US 2024/0286624 A1
(43) Pub. Date: Aug. 29, 2024

(54) SCALABLE AND RELIABLE MONITORING OF PROTECTED ENDPOINTS

(71) Applicant: GM Cruise Holdings LLC, San Francisco, CA (US)

(72) Inventors: Nitish Krishna Kaveri Poompatnam Chandrasekaran, Pleasanton, CA (US); Dannen Roberts, Somerville, MA (US)

(73) Assignee: GM Cruise Holdings LLC, San Francisco, CA (US)

(21) Appl. No.: 18/175,754

(22) Filed: Feb. 28, 2023

(51) Int. Cl. B60W 50/02; G07C 5/00

(52) U.S. Cl. CPC B60W 50/0205; G07C 5/008

(57) ABSTRACT

Applications supporting operations of an autonomous vehicle fleet can be implemented on and supported by cluster infrastructure. These applications have endpoints where data traffic runs in and out of these applications. Monitoring the health of these endpoints can be performed by a third-party vendor solution. Third-party vendor solutions cannot access protected endpoints in the cluster infrastructure easily. Also, some solutions are resource intensive. To address some of these shortcomings, an endpoint monitoring system can be developed by cluster operators and implemented directly on the cluster infrastructure based on a producer-consumer model. The consumers of the model can perform health checks on the protected endpoints in the cluster using the same authorized path as other users of the cluster infrastructure.

### BACKGROUND

### Technical field

The present disclosure generally relates to cluster infrastructure and, more specifically, to scalable and reliable endpoint monitoring solutions.

### Introduction

Cluster infrastructure can include hardware and software resources deployed to support systems with high availability, scalability, and performance. Systems can be deployed on the cluster infrastructure, and the cluster infrastructure enables the systems to service requests being made to the systems.

Autonomous vehicles (AVs), also known as self-driving cars, and driverless vehicles, may be vehicles that use multiple sensors to sense the environment and move without human input. Technology in AVs may enable vehicles to drive on roadways and to accurately and quickly perceive the vehicle's environment, including obstacles, signs, and traffic lights. AV technology may utilize geographical information and semantic objects (such as parking spots, lane boundaries, intersections, crosswalks, stop signs, and traffic lights) for facilitating vehicles in making driving decisions. The vehicles can be used to pick-up passengers and drive the passengers to selected destinations. The vehicles can also be used to pick-up packages and/or other goods and deliver the packages and/or goods to selected destinations.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an exemplary system environment that may be used to facilitate AV operations, according to some aspects of the disclosed technology,

FIG. 2 illustrates an exemplary endpoint monitor operating on endpoints in a cluster, according to some aspects of the disclosed technology,

FIG. 3 illustrates an exemplary client of a cluster accessing a protected resource in the cluster, according to some aspects of the disclosed technology,

FIG. 4 illustrates an exemplary producer-consumer system having producers, a message queue, and consumers, according to some aspects of the disclosed technology,

FIG. 5 illustrates a worker to execute and evaluate tests of a protected endpoint, according to some aspects of the disclosed technology,

FIG. 6 is a flow diagram illustrating an exemplary computer-implemented method for monitoring endpoints in a cluster, according to some aspects of the disclosed technology,

FIG. 7 is a flow diagram illustrating an exemplary computer-implemented method for monitoring endpoints in a cluster, according to some aspects of the disclosed technology, and

FIG. 8 illustrates an exemplary processor-based system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details that provide a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

### Overview

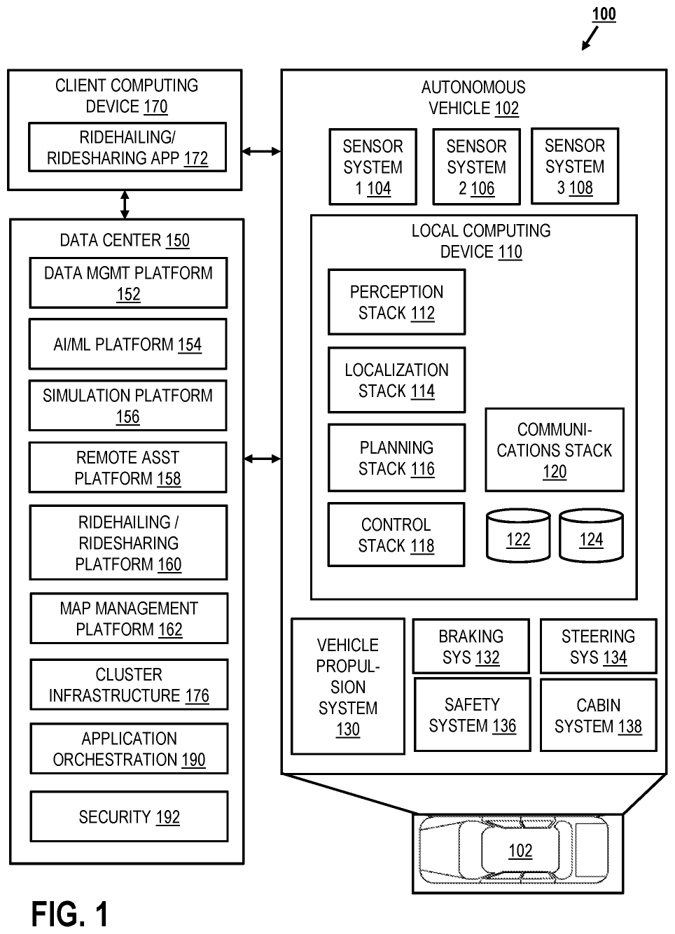

Applications that support operations of an autonomous vehicle fleet can be implemented on and supported by cluster infrastructure. Examples of such applications (and platforms) are described with FIG. 1. Many of these applications implemented on cluster infrastructure have endpoints, or application programming interfaces (APIs). An endpoint allows data traffic to run in and out of the applications. The health of these endpoints can significantly impact operations.

Endpoints within cluster infrastructure are preferably protected by security measures, so that only authenticated and authorized users or services may reach and access these endpoints. Monitoring the health of these endpoints can be performed by a third-party vendor solution. However, third-party vendor solutions cannot access protected endpoints in the cluster infrastructure easily, since these solutions may not support dynamic loading of secrets. In addition, it may not be desirable to expose internal security systems or provide secrets to third-party vendors. Besides, some solutions are resource intensive.

To address some of these shortcomings, an endpoint monitoring system can be modeled as an operator object in the application orchestration system of the cluster infrastructure and implemented directly on the cluster infrastructure based on a producer-consumer model. The producer-consumer model comprises test operators as producers, and workers in a worker pool as consumers. A message queue can store messages (e.g., tests to be executed), and the workers in the worker pool can subscribe to the message queue and execute the tests fetched from the queue. The resulting endpoint monitoring system is scalable and resilient. The system also adheres to the principle of separation of concerns.

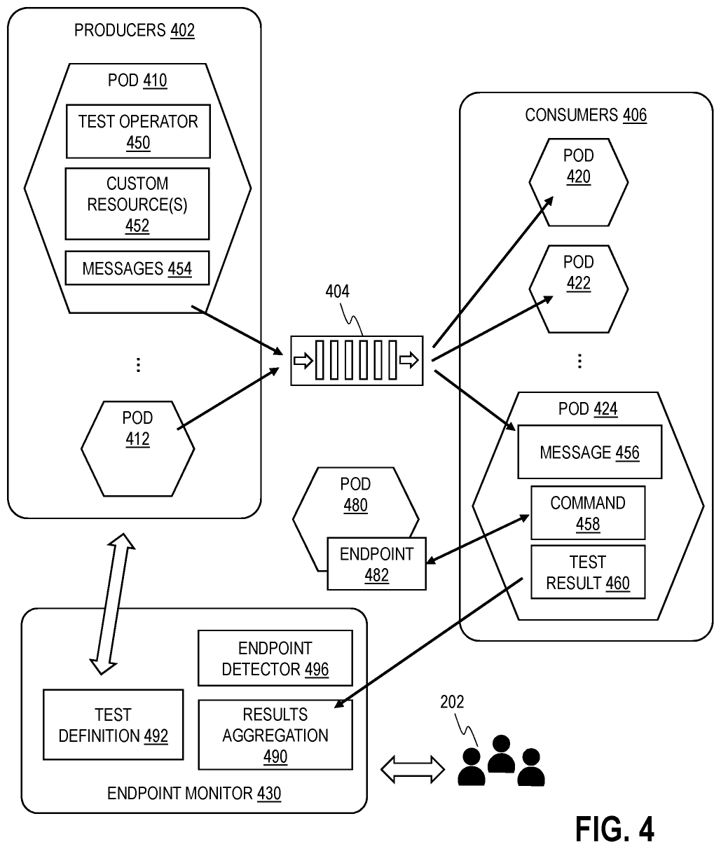

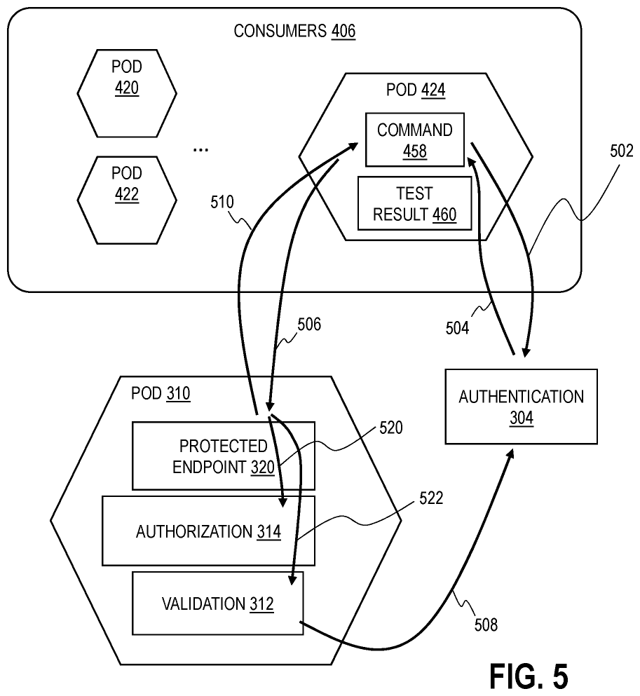

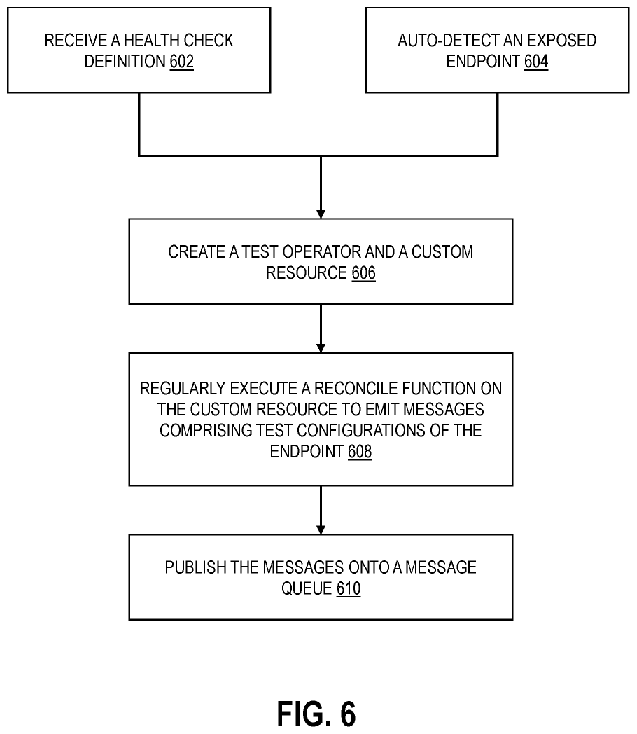

System design is illustrated in FIG. 4. Various computer-implemented methods for performing health checks on endpoints in a cluster are illustrated in FIGS. 5-6.

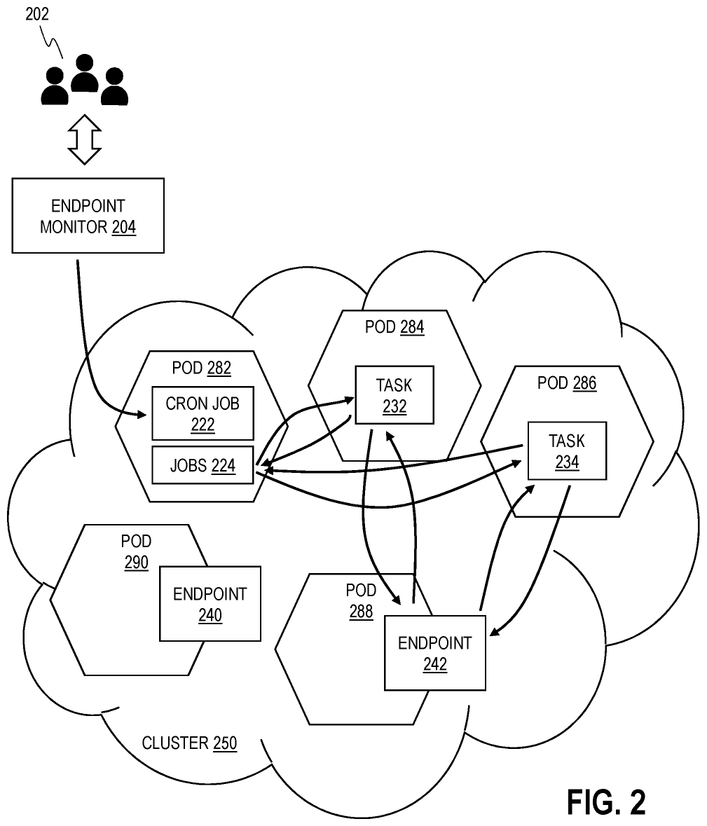

Because the system can be implemented as an operator in the application orchestration system already provided in the cluster infrastructure, the consumers of the model can readily perform health checks on the protected endpoints in the cluster using the same authorized path as other users of the cluster infrastructure. The authorized path that a consumer can take is illustrated in FIGS. 2 and 5.

### Systems for an AV Fleet Supported by Cluster Infrastructure

To better understand the varied systems that can be implemented on cluster infrastructure, FIG. 1 illustrates an exemplary system environment that may be used to facilitate AV operations, according to some aspects of the disclosed technology.

One of ordinary skill in the art will understand that, for the AV management system 100 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 may communicate with one another over one or more networks.

AV 102 may navigate about roadways without a human driver based on sensor signals generated by multiple sensor systems 104, 106, and 108. The sensor systems 104-108 may include different types of sensors and may be arranged about the AV 102. For instance, the sensor systems 104-108 may comprise Inertial Measurement Units (IMUs), cameras (e.g., still image cameras, video cameras, etc.), light sensors (e.g., light detection and ranging (LIDAR) systems, ambient light sensors, infrared sensors, etc.), radio detection and ranging (RADAR) systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 may be a camera system, the sensor system 106 may be a LIDAR system, and the sensor system 108 may be a RADAR system. Other embodiments may include any other number and type of sensors.

AV 102 may also include several mechanical systems that may be used to maneuver or operate AV 102. For instance, the mechanical systems may include vehicle propulsion system 130, braking system 132, steering system 134, safety system 136, and cabin system 138, among other systems. Vehicle propulsion system 130 may include an electric motor, an internal combustion engine, or both. The braking system 132 may include an engine brake, a wheel braking system (e.g., a disc braking system that utilizes brake pads), hydraulics, actuators, and/or any other suitable componentry configured to assist in decelerating AV 102. The steering system 134 may include suitable componentry configured to control the direction of movement of the AV 102 during navigation. Safety system 136 may include lights and signal indicators, a parking brake, airbags, and so forth. The cabin system 138 may include cabin temperature control systems, in-cabin entertainment systems, and so forth. In some embodiments, the AV 102 may not include human driver actuators (e.g., steering wheel, handbrake, foot brake pedal, foot accelerator pedal, turn signal lever, window wipers, etc.) for controlling the AV 102. Instead, the cabin system 138 may include one or more client interfaces (e.g., GUIs, Voice User Interfaces (VUIs), etc.) for controlling certain aspects of the mechanical systems 130-138.

AV 102 may additionally include a local computing device 110 that is in communication with the sensor systems 104-108, the mechanical systems 130-138, the data center 150, and the client computing device 170, among other systems. The local computing device 110 may include one or more processors and memory, including instructions that may be executed by the one or more processors. The instructions may make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a planning stack 116, a control stack 118, a communications stack 120, an HD geospatial database 122, and an AV operational database 124, among other stacks and systems. Collectively, a perception stack 112, a mapping and localization stack 114, a planning stack 116, a control stack 118 of the local computing device 110 may provide functionalities of an AV stack.

Perception stack 112 may enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 122, other components of the AV, and other data sources (e.g., the data center 150, the client computing device 170, third-party data sources, etc.). The perception stack 112 may detect and classify objects and determine their current and predicted locations, speeds, directions, and the like. In addition, the perception stack 112 may determine the free space around the AV 102 (e.g., to maintain a safe distance from other objects, change lanes, park the AV, etc.). The perception stack 112 may also identify environmental uncertainties, such as where to look for moving objects, flag areas that may be obscured or blocked from view, and so forth.

Mapping and localization stack 114 may determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 may compare sensor data captured in real-time by the sensor systems 104-108 to data in the HD geospatial database 122 to determine its precise (e.g., accurate to the order of a few centimeters or less) position and orientation. The AV 102 may focus its search based on sensor data from one or more first sensor systems (e.g., GPS) by matching sensor data from one or more second sensor systems (e.g., LIDAR). If the mapping and localization information from one system is unavailable, the AV 102 may use mapping and localization information from a redundant system and/or from remote data sources.

The planning stack 116 may determine how to maneuver or operate the AV 102 safely and efficiently in its environment. For example, the planning stack 116 may receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 102 from one point to another. The planning stack 116 may determine multiple sets of one or more mechanical operations that the AV 102 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 116 may select from multiple backup plans to carry out. For example, while preparing to change lanes to turn right at an intersection, another vehicle may aggressively cut into the destination lane, making the lane change unsafe. The planning stack 116 could have already determined an alternative plan for such an event, and upon its occurrence, help to direct the AV 102 to go around the block instead of blocking a current lane while waiting for an opening to change lanes.

The control stack 118 may manage the operation of the vehicle propulsion system 130, the braking system 132, the steering system 134, the safety system 136, and the cabin system 138. The control stack 118 may receive sensor signals from the sensor systems 104-108 as well as communicate with other stacks or components of the local computing device 110 or a remote system (e.g., the data center 150) to effectuate the operation of the AV 102. For example, the control stack 118 may implement the final path or actions from the multiple paths or actions provided by the planning stack 116. The implementation may involve turning the routes and decisions (e.g., a trajectory) from the planning stack 116 into commands for the actuators that control the AV's steering, throttle, brake, and drive unit.

The communication stack 120 may transmit and receive signals between the various stacks and other components of the AV 102 and between the AV 102, the data center 150, the client computing device 170, and other remote systems. The communication stack 120 may enable the local computing device 110 to exchange information remotely over a network. The communication stack 120 may also facilitate local exchange of information, such as through a wired connection or a local wireless connection.

The HD geospatial database 122 may store HD maps and related data of the streets upon which the AV 102 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left-turn lanes; permissive, protected/permissive, or protected only U-turn lanes; permissive or protected only right-turn lanes; etc.). The traffic controls layer may include geospatial information of traffic signal lights, traffic signs, and other road objects and related attributes.

The AV operational database 124 may store raw AV data generated by the sensor systems 104-108 and other components of the AV 102 and/or data received by the AV 102 from remote systems (e.g., the data center 150, the client computing device 170, etc.). In some embodiments, the raw AV data may include HD LIDAR point cloud data, image or video data, RADAR data, GPS data, and other sensor data that the data center 150 may use for creating or updating AV geospatial data.

The data center 150 may include cluster infrastructure 176, and application orchestration 190 (e.g., software that orchestrates deployments and maintenance of systems and services onto the cluster infrastructure 176). In some cases, system 100 may have one or more data centers, similar to data center 150. The one or more data centers may not be limited to a singular geographical location.

Cluster infrastructure 176 may include hardware resources and software resources. Hardware resources can include computing/processing resources, data storage resources, network resources, etc. Examples of computing/processing resources may include machine-learning processors (e.g., machine-learning accelerators or neural processing unit), central processing units (CPUs), graphics processing units (GPUs), quantum computers, etc. Examples of data storage resources may include disk storage devices, memory storage devices, database servers, etc. Network resources may include network appliances (e.g., switches, routers, etc.), network connections, interconnects, etc. Software resources may include firmware for the hardware resources, operating systems for the hardware resources, virtual machines running on the hardware resources, software that manage the hardware resources, etc. Cluster infrastructure 176 may include resources managed by one or more providers.

Application orchestration 190 may include software that work with cluster infrastructure 176 to deploy and maintain systems and services (sometimes referred to as applications) running on the cluster infrastructure 176. Application orchestration 190 may allow users of cluster infrastructure 176 to configure, deploy, coordinate, and manage applications on cluster infrastructure 176. Some application orchestration 190 may provide resource usage optimization, achieve certain quality of service parameters, and load balancing of the applications on cluster infrastructure 176. While not required, applications deployed on cluster infrastructure 176 can be containers (or containerized applications). A container means that the code and dependencies are packaged as a unit or image (e.g., having code, runtime, system tools, system libraries and settings) in such a way that the application can be created and run quickly on cluster infrastructure 176 regardless of the underlying cluster infrastructure environment.

The data center 150 may send and receive various signals to and from the AV 102 and the client computing device 170. These signals may include sensor data captured by the sensor systems 104-108, roadside assistance requests, software updates, ridesharing pick-up and drop-off instructions, and so forth.

In this example, the data center 150 includes one or more of a data management platform 152, an Artificial Intelligence/Machine-Learning (AI/ML) platform 154, a simulation platform 156, a remote assistance platform 158, a ridehailing/ridesharing platform 160, and a map management platform 162, among other systems. Many of these systems can be implemented and supported by cluster infrastructure 176.

The data center 150 having cluster infrastructure 176 may be a private cloud (e.g., an enterprise network, a co-location provider network, etc.), a public cloud (e.g., an infrastructure as a service (IaaS) network, a platform as a service (PaaS) network, a software as a service (SaaS) network, or other communication service provider (CSP) network), a hybrid cloud, a multi-cloud, and so forth. The data center 150 may include cluster infrastructure 176, which can include hardware and software resources remote to the local computing device 110 for managing a fleet of AVs and AV-related services. For example, in addition to managing the AV 102, the data center 150 may also support a ridehailing/ridesharing service, a delivery service, a remote/roadside assistance service, street services (e.g., street mapping, street patrol, street cleaning, street metering, parking reservation, etc.), sensor calibration, and the like.

Data management platform 152 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 may access data stored by the data management platform 152 to provide their respective services.

The AI/ML platform 154 may provide the systems for training and evaluating machine-learning algorithms for operating the AV 102 (e.g., machine-learning models used in the AV stack), the simulation platform 156, the remote assistance platform 158, the ridehailing/ridesharing platform 160, the map management platform 162, and other platforms and systems. Using the AI/ML platform 154, data scientists may prepare data sets from the data management platform 152; select, design, and train machine-learning models; evaluate, refine, and deploy the models; maintain, monitor, and retrain the models; and so on.

The simulation platform 156 may simulate (or mimic) and/or augment real-world conditions (e.g., roads, lanes, buildings, obstacles, other traffic participants (e.g., other vehicles, cyclists, and pedestrians), trees, lighting conditions, weather conditions, etc.) so that the AV stack of an AV may be tested in a virtual environment that is similar to a real physical world. The simulation platform 156 may create a virtual environment that emulates physics of the real-world and sensors of an AV. Testing and evaluating AVs in simulation platform 156 can be more efficient and allow for creation of specific traffic scenarios that may occur rarely in the real-world. Moreover, the AV stack can even be tested in thousands of scenarios in parallel in simulation. More specifically, the AV stack may be executed in a simulator simulating various traffic scenarios at a time. With simulation platform 156, the AV stack implementing the perception, prediction, planning, and control algorithms can be developed, evaluated, validated, and fine-tuned in a simulation environment. The simulation platform 156 can also be used to evaluate only a portion of the AV stack.

The remote assistance platform 158 may generate and transmit instructions to control the operation of the AV 102. For example, in response to active trigger(s) being detected by the local computing device 110 on the AV 102, the remote assistance platform 158 may respond by creating a remote assistance session with a remote assistance operator to assist the AV 102. The remote assistance platform 158 may, with assistance from the remote assistance operator, generate and transmit instructions to the AV 102 to cause the AV 102 to perform a special driving maneuver (e.g., to drive AV 102 in reverse). The remote assistance platform 158 may utilize the remote assistance session to communicate with a customer in the AV 102 via the client computing device 170 to resolve concerns of the customer.

The ridehailing/ridesharing platform 160 (e.g., a web application) may interact with a customer of a ridehailing/ridesharing service via a ridehailing/ridesharing application 172 executing on the client computing device 170. Ridehailing/ridesharing platform 160 may provide delivery services as well. The client computing device 170 may be any type of computing system, including a server, desktop computer, laptop, tablet, smartphone, smart wearable device, gaming system, or other general-purpose computing device for accessing the ridehailing/ridesharing application 172. The client computing device 170 may be a customer's mobile computing device or a computing device integrated with the AV 102 (e.g., the local computing device 110). The ridehailing/ridesharing platform 160 may receive requests to be picked up or dropped off from the ridehailing/ridesharing application 172, and dispatch the AV 102 for the trip. A similar platform can be provided for delivery services.

Map management platform 162 may provide a set of tools for the manipulation and management of geographic and spatial (geospatial) and related attribute data. The data management platform 152 may receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data may be processed, and map management platform 162 may render base representations (e.g., tiles (2D), bounding volumes (3D), etc.) of the AV geospatial data to enable users to view, query, label, edit, and otherwise interact with the data. Map management platform 162 may manage workflows and tasks for operating on the AV geospatial data. Map management platform 162 may control access to the AV geospatial data, including granting or limiting access to the AV geospatial data based on user-based, role-based, group-based, task-based, and other attribute-based access control mechanisms. Map management platform 162 may provide version control for the AV geospatial data, such as to track specific changes that (human or machine) map editors have made to the data and to revert changes when necessary. Map management platform 162 may administer release management of the AV geospatial data, including distributing suitable iterations of the data to different users, computing devices, AVs, and other consumers of HD maps. Map management platform 162 may provide analytics regarding the AV geospatial data and related data, such as to generate insights relating to the throughput and quality of mapping tasks.

Data center 150 may include security 192. Security 192 may implement systems and security protocols to manage user/service/application authentication and authorization to secure and protect resources in the cluster infrastructure 176. For instance, security 192 may include identities (and roles) management (e.g., to maintain a database of users/services/applications that may need to have certain rights in the cluster infrastructure 176). Security 192 may include authorities that can verify identities and issue tokens or certificates for authenticated users/services/applications. The authorities may revoke tokens or certificates if appropriate. Security 192 may implement authorization protocols to verify whether authenticated users/services/applications have rights to perform certain actions. Authorization protocols can allow authenticated users/services/applications to perform authorized actions, and disallow those users/services/applications to perform unauthorized actions. Security 192 may implement encryption and decryption of data. Security 192 may include one or more ingress instances (or ingress pods). An ingress instance can disallow data traffic that does not have a token/certificate and only allow data traffic with a valid token to pass through the ingress instance to its destination. In some cases, an ingress instance may attach application-specific tokens to the data traffic based on the destination of the data traffic.

Data management platform 152, AI/ML platform 154, simulation platform 156, remote assistance platform 158, ridehailing/ridesharing platform 160, map management platform 162 are some illustrative examples of applications that can be orchestrated by application orchestration 190 so that they can be deployed and implemented on cluster infrastructure 176. These platforms and other similar applications/platforms/services may include endpoints, or APIs. Endpoints allow users/services/applications to communicate with these applications/platforms/services. For instance, endpoints allow users/services/applications to access resources or execute commands on these applications/platforms/services. For example, an endpoint can accept Hypertext Transfer Protocol (HTTP) requests from users/services/applications. An endpoint can be accessible and addressable via a unique resource locator (URL). Health of these endpoints can impact operations of these platforms and a fleet of AVs that are supported by these platforms.

Because the health of these endpoints can be critical to operations, applications running on the cluster can benefit from endpoint monitoring so that cluster operators and managers can be alerted and informed timely when health issues relating to cluster applications arise. Endpoint monitoring can include one or more aspects of health monitoring or checks on these endpoints. Endpoint monitoring can transmit a variety of requests and in some cases a chain of requests to an endpoint. The endpoint may transmit responses to the requests. Endpoint monitoring may evaluate the responses to determine health metrics of the endpoint. Endpoint monitoring may include uptime monitoring (e.g., whether an endpoint is alive/up, whether an endpoint is down). Endpoint monitoring may include performance measurement (e.g., how quickly requests are being serviced, and how quickly responses are being transmitted back). Endpoint monitoring may include data validation (e.g., whether responses are returning expected data). The metrics can be aggregated to inform the cluster operators and managers of the platform whether there are issues in the platform or outages in the cluster infrastructure.

Endpoint monitoring may include verifying that a protected/secured endpoint continues to be protected/secured, e.g., using an expected failed test. An unauthenticated and/or unauthorized request may be transmitted to a protected endpoint, and a failure of the unauthenticated and/or unauthorized request is expected. If unauthenticated and/or unauthorized requests are sent routinely and consistently fail to get a response (or consistently get a response that indicates failure or denial), endpoint monitoring may confirm that expected authentication and/or authorization mechanisms are working properly (because the requests are being denied as expected). If an authenticated and/or unauthorized request is accepted, then endpoint monitoring may deduce that the expected authentication and/or authorization mechanisms are not working properly.

While many endpoints described herein refer to endpoints in a cluster, it is envisioned by the disclosure that the systems and methods described herein for monitoring health of endpoints can be applicable for other kinds of endpoints, such as endpoints in applications running on client devices such as client computing device 170, applications running on AVs such as autonomous vehicle 102, and applications running on Internet of Things (IoT) devices (e.g., devices that collect data and transmit data over a network).

### Exemplary Cluster Having Nodes and Pods Deployed on Nodes

Cluster infrastructure 176 may include one or more clusters. A cluster operator may define and provision resources in a cluster using a suitable infrastructure manager through machine-readable definition files. Applications (and services) can be deployed onto a cluster using application orchestration (e.g., application orchestration 190 of FIG. 1). Application orchestration can orchestrate deployment, maintenance, and scaling of applications on the resources in a cluster. Application orchestration can implement a control plane in the cluster that may service requests for application deployment and requests for maintaining applications running on the cluster. In some embodiments, a control plane may include persistent, lightweight, distributed key-value data store to store configuration data of the cluster, an application programming interface, a scheduler to assign unscheduled applications to a specific resource in the cluster, one or more controllers/operators each having a reconciliation loop, and a controller manager that manages the one or more controllers/operators. The control plane may orchestrate applications onto resources in the cluster, which may be organized and managed by the control plane using nodes and optionally node pools.

A cluster may have one or more nodes. A node (also called a worker) may be a resource on which an application (e.g., systems, services, workloads, etc.) can be deployed. A node may include a virtual or physical machine. Virtual machines are machines that emulate physical machines and are implemented on physical hardware. A node has a corresponding configuration. The configuration may include properties such as a machine type, a resource type, a specific operating system image, a minimum computing platform, amount of allocable data and/or computing resources for the node (also referred to as a shape of a node), a specific network interface, maximum number of applications that can run on the node, etc. The health/status of the node may be managed by the control plane. A node pool (also called a worker pool) may be a group of nodes within a cluster that all have the same configuration. A cluster may have one or more node pools.

An application, e.g., a unit that can be handled by the scheduler in the control plane is referred to herein as a pod. A pod may include a containerized application. The scheduler may schedule and deploy pods to nodes or node pools based on the configurations and health/state of the nodes or node pools. The control plane may schedule and deploy one or more pods on a given node. An application deployed as a pod on a node may have one or more resources and/or one or more endpoints. For simplicity, nodes and node pools on which pods are deployed are not shown in the figures. In some cases, a pod deployed on a node may be referred to as a worker. Pods deployed on node pools may be referred to as workers in a worker pool.

### Resource Intensive Endpoint Monitor Systems

FIG. 2 illustrates an exemplary endpoint monitor 204 operating on endpoints in a cluster 250, according to some aspects of the disclosed technology. Cluster operators 202 (or managers/operators of applications/services deployed on the cluster 250) may submit health check definitions to endpoint monitor 204. Endpoint monitor 204 may be tasked, based on the health check definitions, to monitor health of various endpoints of pods deployed in cluster 250. For simplicity, nodes and node pools on which pods are deployed are not shown in the figure. Examples of endpoints that can be monitored by endpoint monitor 204 include endpoint 240 of pod 290, and endpoint 242 of pod 288. Endpoint monitor 204 may be implemented outside of cluster 250. Endpoint monitor 204 may be implemented as one or more pods inside cluster 250.

One exemplary health check definition provided by cluster operators 202 to endpoint monitor 204 may specify a health check or a test on endpoint 242. For example, a health check or test may specify that a type of request is transmitted to endpoint 242 at a certain cadence/frequency. The test may specify an assertion that defines an expected response to the transmitted request from endpoint 242. Such a health check definition may be implemented as a cron job on a pod (e.g., cron job 222 on pod 282). Cron job 222 may create jobs 224 on a repeating schedule. A cron job can perform tasks at a certain cadence or frequency, or according to a schedule. A cron job can also be called a repetitive task scheduler. Implementing a cron job 222 can add significant load on cluster 250. Cron job 222 may create many jobs (e.g., jobs 224) to perform the health check or test at the specified cadence/frequency. For each job, many transient pods may be created to execute tasks within each job. In some cases, a pod may be created/spawned to run an endpoint test command, each time an endpoint test command is needed. For example, pod 284 may be created to perform a task 232 of a job in jobs 224 (e.g., send a command to endpoint 242 and receive a response from endpoint 242), and to pass back results of the task 232 to pod 282. Pod 286 may be created to perform a task 234 of the same job in jobs 224, and to pass back results of the task 234 to pod 282 (e.g., send a command to endpoint 242 and receive a response from endpoint 242). As a result, many pods and nodes are used to support a cron job (e.g., cron job 222), and the solution can take up significant resources in the cluster (e.g., use up many Internet Protocol (IP) addresses, put a heavy load and add noise on the cluster, etc.). Creating many pods to perform tasks may lead to an unstable system. Some of these problems may become worse as the number of health checks or tests to be performed on endpoints in the cluster 250 increases.

Endpoint tests may be sent using a tool that allows data transfers using a URL. An endpoint test tool may transmit endpoint test commands to perform endpoint tests. The endpoint test command may have a URL and one or more options. An example of an endpoint test command is “endpoint-test https://abc.xyz/endpoint”. An endpoint test tool may support a number of data transfer protocols, and allows clients to execute a command at an endpoint addressable by a URL. For example, an endpoint test command may be used to execute one or more HTTP requests on an endpoint addressable by a URL.

### An Exemplary Authorized Path for Accessing a Protected Resource

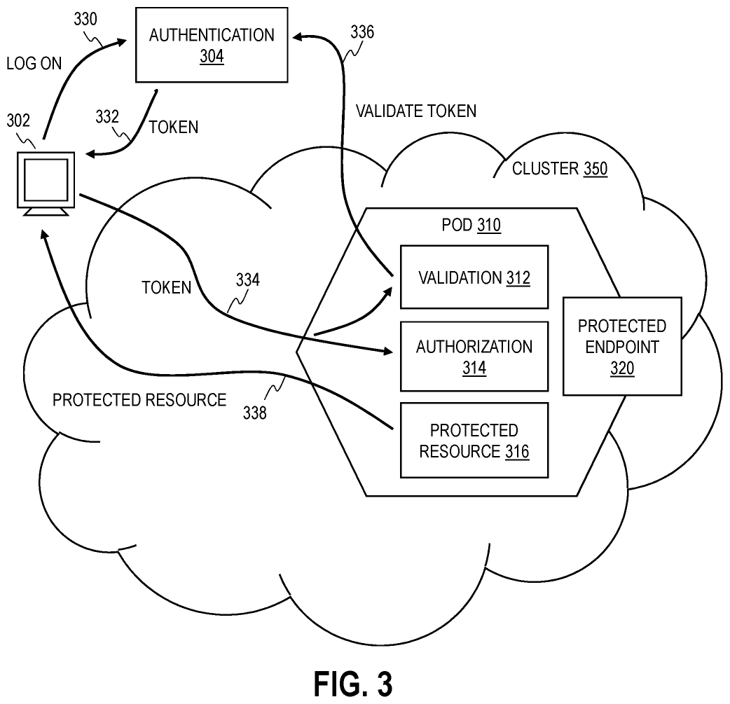

FIG. 3 illustrates an exemplary client 302 of a cluster 350 accessing a protected resource in cluster 350, according to some aspects of the disclosed technology. In some cases, resources are protected by authentication and authorization schemes, such that only authenticated and authorized users/services/applications can access a protected resource. Users/services/applications are illustrated as client 302. In 330, client 302 may log on (e.g., provide a password or a secret) and request a token from authentication 304. In 332, if the log on operation is successful, authentication 304 may provide a token (or other suitable credentials) to client 302. In 334, using the token, client 302 may transmit a request to access a protected resource 316 (e.g., to execute a command on pod 310, or retrieve data from pod 310). In 336, validation 312 on pod 310 may request authentication 304 to validate client 302's token. Authorization 314 may determine whether the client 302 (e.g., an authenticated client) is authorized to access the protected resource 316 (e.g., using an access control list). In 338, in response to determining that the client 302 is authorized to access the protected resource 316, pod 310 may provide client 302 access to the protected resource 316.

Endpoints in cluster 350, such as protected endpoint 320, may be protected or secured from receiving and/or processing requests sent from unauthenticated and unauthorized clients in a similar fashion. Clients that would like to test protected endpoint 320 may transmit requests to protected endpoint 320 via the same authorized path that client 302 took to access protected resource 316.

Some endpoint monitoring systems may not support dynamic loading of secrets and retrieval of tokens to access protected endpoints such as protected endpoint 320 through the authorized path illustrated in FIG. 3. If an endpoint monitoring system is provided by a third-party vendor that is not the same party as the cluster operators 202 managing cluster 250, allowing a third-party vendor to have secrets may create a security vulnerability. It may not be ideal for cluster operators and operators/managers of the applications deployed on cluster infrastructure to be reliant on a third-party vendor solution. If the third-party vendor solution is down, then no endpoint monitoring would be performed.

### A Resilient, Scalable, and Reliable Endpoint Monitoring System

To address some of the concerns, an endpoint monitoring system comprising producers, a message queue, and consumers can be implemented directly onto the cluster infrastructure. Following a producer-consumer model, test operators can generate tests and act as the producers, and workers in a worker pool can execute the tests and act as the consumers. A message queue can store messages (e.g., tests generated by test operators), and workers in the worker pool can poll the message queue for tests to execute.

As used herein, a test operator is a process that can be implemented on hardware resources on cluster infrastructure. The test operator may have a reconciliation/control loop, and may reconcile a custom resource by executing a reconcile function regularly. Regularly can include one or more of: every 5 minutes, every X minutes, every hour, every day, and/or upon request. The test operator may execute or perform a reconcile function at a certain cadence, upon request, and/or when triggered. A test operator may modify a real-world state to match a desired state specified in the custom resource. The test operator is not to be confused with human operators or cluster operators.

The system can have one or more benefits. The endpoint monitoring system follows a producer-consumer model where producers and consumers are responsible for different tasks. The system thus adheres to a separation of concerns design principle. The system can be simpler to implement, maintain, update, and debug. Moreover, the model allows producers to scale easily if more health checks and tests are to be performed, and allows consumers to scale easily if throughput in the message queue increases. The implementation of producers and consumers can leverage design patterns, principles, and objects offered by application orchestration of the cluster infrastructure, and avoid using cron jobs which can be resource intensive. Such an implementation would use fewer pods, can consume far fewer IP addresses, and impose less load and noise on the cluster. Since the system is implemented in-house directly in the cluster infrastructure, secrets no longer have to be provided to a third-party vendor. Uptime of the endpoint monitoring system also would no longer depend on the third-party vendor.

FIG. 4 illustrates an exemplary producer-consumer system having producers 402, a message queue 404, and consumers 406, according to some aspects of the disclosed technology. Similar to FIG. 2, cluster operators 202 (or managers/operators of applications/services deployed on the cluster) may submit health check definitions or test definitions (e.g., test definition 492) to endpoint monitor 430. Health check definitions or test definitions may include default test definitions, e.g., having a basic set of test(s) on a given endpoint. One or more test operators deployed in a cluster as pods can be implemented to create/generate tests in accordance with test definition 492. One or more workers deployed in the cluster as pods can be implemented to execute tests in accordance with test definition 492. For simplicity, nodes and node pools are not shown in the figure.

Endpoint monitor 430 may deploy one or more pods to act as producers 402. In the system, producers 402 are tasked to generate tests regularly and routinely based on test definitions, e.g., test definition 492. In the example illustrated, producers 402 may include one or more pods, e.g., pod 410, . . . pod 412. A pod can implement an operator and one or more custom resources. As an example, pod 410 may implement a test operator 450 as the operator, and one or more custom resources 452. An operator (as a design pattern), such as test operator 450, may implement a control loop. An operator may implement a control loop that routinely or regularly runs/calls a reconcile function on a custom resource to reconcile the custom resource. The test operator 450 may reconcile one or more custom resources 452 to cause tests (or test configurations) of an endpoint in a cluster to be generated and emitted at a certain cadence or frequency (e.g., cadence or frequency specified in test definition 492). The tests may be included and emitted as messages 454.

Tests may include endpoint tests (or endpoint test commands) to a URL of the endpoint in the cluster. Tests may include pings to a URL of the endpoint in the cluster. Tests may include health tests to an endpoint (e.g., an application programming interface) in the cluster. A test configuration of an endpoint may include a URL of the endpoint, a test on the endpoint (e.g., type of request to be sent), and an assertion corresponding to an expected result of the test (e.g., an expected value or response to the test).

One exemplary custom resource (in custom resource(s) 452) is a cron test resource, which may represent a state of a cron job (e.g., a repetitive task scheduler). The operator, e.g., test operator 450, may regularly run a reconcile function to cause tests of an endpoint in the cluster to be generated and emitted. For example, test operator 450 may create an endpoint test every N minutes (e.g., every 5 minutes). Test operator 450 may determine whether time elapsed from a time when a last test (e.g., an endpoint test) was created is greater than a predefined period of time. In response to the time elapsed being greater than the predefined period of time, create a new test of the endpoint (e.g., a new endpoint test). The cron test resource may store the time when the last test was created, and the reconcile function may be executed and completed by (1) determining it is too soon to create a new test based on the predefined period of time, or (1) determining that it is time and successfully creating a new test

Another exemplary custom resource (in custom resource(s) 452) is an endpoint test resource, which may represent whether a message comprising a created test has been placed in message queue 404 or not. The operator, e.g., test operator 450, may regularly run/execute a reconcile function to cause messages having the tests to be placed in message queue 404. In other words, the endpoint test resource may be reconciled by test operator 450 by placing a message that has a test configuration of a test generated by reconciling the endpoint test resource (e.g., each time the reconcile function is completed on the endpoint test resource). For example, the test operator 450 may reconcile the endpoint test resource by placing a message having a configuration of a endpoint test on the endpoint into the message queue 404. The test operator 450 may mark the reconcile function complete upon placing the message into the message queue 404.

The message queue 404 may be a first-in-first-out queue. The message queue 404 may receive tests of the endpoint and other endpoints in the cluster, submitted as messages such as messages 454, from the one or more producers 402 (e.g., test operators). The message queue 404 can receive messages from one or more producers 402. A consumer of consumers 406 may pop messages in the message queue 404 for further processing. In some embodiments, the message queue 404 may be implemented as a publisher-subscriber message queue. Besides separating producers 402 and consumers 406, the message queue 404 may provide persistent storage of a state of the endpoint monitoring system, which can make the endpoint monitoring system more resilient against failures in the nodes/pods in the cluster or cluster outages.

Consumers 406 may be referred herein as a worker pool. Consumers 406 may include a plurality of workers (e.g., illustrated as a plurality of pods such as pod 420, pod 422, . . . and pod 424). The worker pool may poll the message queue 404. Workers in the worker pool may consume the messages in the message queue 404. Workers in the worker pool may execute and evaluate tests specified in the messages.

In some cases, the worker pool may be set to auto-scale (e.g., by application orchestration of the cluster). The number of workers in the worker pool may automatically adjust (e.g., increase or decrease) depending on the demand for workers (and resources) to execute and evaluate tests. Auto-scaling may be performed based on a number of factors, such as the throughput of the message queue 404. Auto-scaling may be performed based on resources being consumed to execute and evaluate the tests specified in the messages.

In some cases, the workers in the worker pool can operate in parallel, e.g., process different messages popped from message queue 404. In some cases, the workers in the worker pool may poll the message queue asynchronously, e.g., as workers become available to execute and evaluate tests.

A worker in the worker pool may be deployed to process a message popped from the message queue 404. For example, pod 424 may be deployed to process message 456 popped from message queue 404. Processing or consuming a message, e.g., message 456, may include translating a configuration of a test (e.g., a test created by test operator 450) in the message into a command that pod 424 can run/execute (e.g., command 458). For example, pod 424 may translate a configuration of an endpoint test on an endpoint in the message 456 into an endpoint test command, and run the endpoint test command on the endpoint. Translating a configuration may include appending parts of an endpoint test command together based on the configuration of an endpoint test provided in the message 456. Running the endpoint test command on the endpoint may include transmitting the endpoint test command to a URL of the endpoint (e.g., endpoint 482 of pod 480). Pod 424 may receive a response to the command 458, and evaluate the response for a test result 460. In some embodiments, pod 424 may execute and evaluate a test specified in a message (e.g., message 456) from the message queue 404. Pod 424 may execute a command 458 corresponding to the test on the endpoint. Pod 424 may evaluate a response to the command to produce a test result 460 or a metric. Evaluating a response may include evaluating whether the response matches the assertion(s) of the test. If the response matches the assertion(s), then the metric may indicate success. If the response does not match the assertion(s), then the metric may indicate failure. Pod 424 may provide the test result 460 or metric to results aggregation 490 of endpoint monitor 430 for one or more of: data aggregation, metrics generation, and alerts generation.

Producers 402 may be concerned with generating tests at a certain cadence or frequency, and may not be concerned with executing the tests, evaluating the tests, producing test results or metrics, and obtaining security tokens. Consumers 406 may be concerned with executing the tests, evaluating the tests, producing test results or metrics, and obtaining security tokens, and may not be concerned with generating tests at a certain cadence or frequency. Accordingly, concerns are separated by design.

In some embodiments, endpoint monitor 430 may include an endpoint detector 496 that watches a cluster for endpoints in the configuration of the cluster. As new pods are provisioned in a new cluster, users of a cluster may submit configurations of (exposed) endpoints for new pods so that network traffic may be routed to those endpoints accordingly. Endpoint detector 496 may check for new (exposed) endpoints (or presence thereof) on a cluster in the submitted configurations, and provision one or more suitable test definitions (e.g., test definition 492, or some default test definition) for the new endpoints. Accordingly, endpoint monitoring may be configured by default for new endpoints detected on a cluster.

An exemplary authorized path for a worker to access a protected endpoint

FIG. 5 illustrates a worker to execute and evaluate tests of a protected endpoint, according to some aspects of the disclosed technology. In some cases, the worker may follow an authorized path to test a protected endpoint, such as an authorized path illustrated in FIG. 3. Authentication 304 (e.g., an authentication system) may provide tokens to workers executing tests. The tokens (or secrets) can allow the workers to be authenticated and authorized to access protected endpoints in the cluster. The tokens may have associated privileges that would allow workers to access, and thus, test, certain endpoints. In 502, to follow an authorized path, pod 424 may request a token from authentication 304 to access protected endpoint 320. In 504, pod 424 may receive a token. In 506, using the token, pod 424 may transmit a command to a protected endpoint 320. In 522, the token received in 506 may be passed to validation 312 for authentication and validation. In 508, validation 312 of pod 310 may validate the token from pod 424 to authenticate pod 424. Authorization 314 of pod 310 may verify whether pod 424 (as an authenticated client) is authorized to access protected endpoint 320. In 520, the token received in 506 may be passed to authorization 314 to perform authorization. If authorized, pod 424 may execute/run command 458 on protected endpoint 320 of pod 310 and receive a response from pod 310 in 510.

In some cases, authorization 314 and/or validation 312 may be implemented on a pod separate from pod 310 (but communicably connected to pod 310).

### Exemplary Methods for Monitoring Endpoints in a Cluster

FIG. 6 is a flow diagram illustrating an exemplary computer-implemented method for monitoring endpoints in a cluster, according to some aspects of the disclosed technology. The method may be carried out by various components illustrated and/or described with FIGS. 4-5.

In 602, an endpoint monitoring system may receive a health check definition from a cluster user (e.g., operator or users of the cluster) on the endpoint in the cluster. A test operator and one or more custom resources may be created based on the received health check definition.

In 604, the endpoint monitoring system may detect a presence of an endpoint in a configuration of the cluster. The endpoint monitoring system may monitor for certain URLs being added or configured in the cluster that may indicate an exposed endpoint. The endpoint monitoring system may monitor for a configuration of the cluster that includes an endpoint that may benefit from endpoint monitoring. The endpoint monitoring system may determine a default health check definition (e.g., a basic set of test(s) or health check(s) on the endpoint). The endpoint monitoring system may select one from a plurality of default health check definitions based on characteristics/configuration of the endpoint. A test operator and one or more custom resources may be created based on the default health check definition.

In 606, an endpoint monitoring system may create/deploy one or more test operators and one or more custom resources based on a health check definition or test definition. Creation or deployment of a test operator and a custom resource may be triggered in one or more ways.

In 608, the test operator may regularly execute a reconcile function on one or more custom resources to emit messages. The messages may include test configurations of the endpoint.

In 610, the test operator may publish the messages onto a message queue. The test operator may submit a message onto the message queue by executing a further reconcile function on a further custom resource. The message queue may be polled asynchronously by workers in a worker pool. The workers in the worker pool may (1) translate the test configurations in the messages into tests (or commands), and (2) execute and evaluate the tests. The workers may perform in parallel.

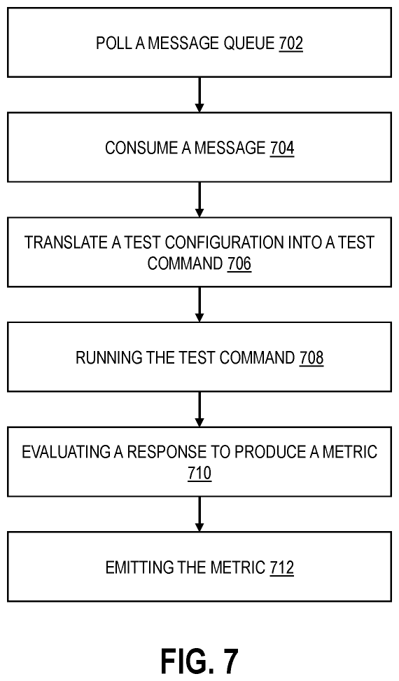

FIG. 7 is a flow diagram illustrating an exemplary computer-implemented method for monitoring endpoints in a cluster, according to some aspects of the disclosed technology. The method may be carried out by various components illustrated and/or described with FIGS. 4-5. In 702, a worker pool having workers may poll a message queue having messages submitted regularly by one or more test operators. The messages correspond to health checks (or tests) on the protected endpoints in the cluster. In 704, a worker in the worker pool may consume a message in the message queue. In 706, the worker may translate a test configuration in the message into a test command on a protected endpoint in the cluster. In 708, the worker may run/execute the test command on the protected endpoint. In 710, the worker may evaluate a response to the test command to produce a metric (e.g., indicating success or failure). In 712, the worker may emit the metric to an endpoint monitoring system. In some cases, the worker may obtain, from an authentication system, a token to allow the worker to be authenticated and authorized to access the protected endpoint.

### Exemplary Processor-Based System

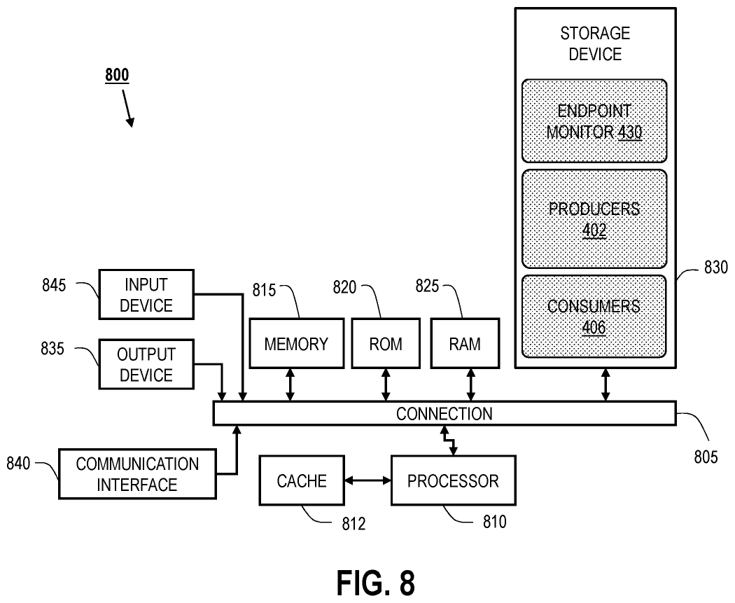

FIG. 8 illustrates an exemplary processor-based system with which some aspects of the subject technology may be implemented. For example, processor-based system 800 may be any computing device making up, or any component thereof in which the components of the system are in communication with each other using connection 805. Connection 805 may be a physical connection via a bus, or a direct connection into processor 810, such as in a chipset architecture. Connection 805 may also be a virtual connection, networked connection, or logical connection.

In some embodiments, computing system 800 represents the local computing device 110 of FIG. 1 and/or the parts of cluster infrastructure 176 in data center 150 of FIG. 1. In some embodiments, one or more of the described system components represents many such components each performing some or all of the function for which the component is described. In some embodiments, the components may be physical or virtual devices.

Exemplary system 800 includes at least one processing unit (e.g., a CPU or another suitable processor) 810 and connection 805 that couples various system components including system memory 815, such as Read-Only Memory (ROM) 820 and Random-Access Memory (RAM) 825 to processor 810. Computing system 800 may include a cache of high-speed memory 812 connected directly with, in close proximity to, or integrated as part of processor 810.

Processor 810 may include any general-purpose processor and a hardware service or software service, such as executable instructions that implement functionalities such as methods and processes described herein. The functionalities carried out by one or more of: endpoint monitor 430, producers 402, consumers 406, be encoded as instructions in storage device 830. Processor 810 may be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms known to those of skill in the art. In some instances, multimodal systems may enable a user to provide multiple types of input/output to communicate with computing system 800. Computing system 800 may include communications interface 840, which may generally govern and manage the user input and system output. The communication interface may perform or facilitate receipt and/or transmission of wired or wireless communications via wired and/or wireless transceivers.

Storage device 830 may be a non-volatile and/or non-transitory and/or computer-readable memory device and may be a hard disk or other types of computer-readable media which may store data that are accessible by a computer.

Storage device 830 may include software services, servers, services, etc. When the code that defines such software is executed by the processor 810, the software may cause the system 800 to perform a function. In some embodiments, a hardware service that performs a particular function may include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special-purpose computer, including the functional design of any special-purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

### Select Examples

Example 1 is a computer-implemented system, comprising: a test operator to (regularly) reconcile a custom resource to emit tests of an endpoint in a cluster, wherein the custom resource represents a state of a repetitive task scheduler; a message queue to receive, tests of the endpoint and other endpoints in the cluster, submitted as messages, from the test operator; and a worker pool having a plurality of workers to poll the message queue, consume the messages in the message queue, and execute and evaluate tests specified in the messages.

In Example 2, the computer-implemented system of Example 1 may optionally include an authentication system to provide tokens to workers executing tests, wherein the tokens allow the workers to be authenticated and authorized to access the endpoints in the cluster.

In Example 3, the computer-implemented system of Example 1 or 2 may optionally include the test operator to (regularly) run a reconcile function on the custom resource to: determine whether time elapsed from a time when a last test was created is greater than a predefined period of time; and in response to the time elapsed being greater than the predefined period of time, create a new test of the endpoint.

In Example 4, the computer-implemented system of any one of Examples 1-3 may optionally include the test operator to (regularly) run a further reconcile function on a further custom resource to: place a message having a configuration of a new test of the endpoint onto the message queue each time the further reconcile function is completed.

In Example 5, the computer-implemented system of any one of Examples 1-4 may optionally include a message in the message queue comprising a configuration of an endpoint test on the endpoint.

In Example 6, the computer-implemented system of any one of Examples 1-5 may optionally include the tests of the endpoint comprising pings to a unique resource locator (URL) of the endpoint in the cluster.

In Example 7, the computer-implemented system of any one of Examples 1-6 can optionally include the tests of the endpoint comprising health tests to an application programming interface in the cluster.

In Example 8, the computer-implemented system of any one of Examples 1-7 can optionally include a worker in the worker pool consuming a message from the message queue; translating a configuration of an endpoint test on an endpoint in the message into an endpoint test command; and running the endpoint test command on the endpoint.

In Example 9, the computer-implemented system of any one of Examples 1-8 can optionally include a worker in the worker pool executing and evaluating a test specified in a message from the message queue; executing a command corresponding to the test on the endpoint; evaluating a response to the command to produce a metric; and emitting the metric to an endpoint monitoring system.

In Example 10, the computer-implemented system of Example 9 can optionally include the metric representing success or failure.

In Example 11, the computer-implemented system of any one of Examples 1-10 can optionally include the worker pool being set to auto-scale based on resources being consumed to execute and evaluate the tests specified in the messages.

In Example 12, the computer-implemented system of any one of Examples 1-11 can optionally include the workers in the worker pool to operate in parallel.

In Example 13, the computer-implemented system of any one of Examples 1-12 can optionally include the workers in the worker pool polling the message queue asynchronously.

In Example 14, the computer-implemented system of any one of Examples 1-13 can optionally include the message queue being a publisher-subscriber message queue.

Example 15 is a computer-implemented method for generating health checks on endpoints in a cluster, the computer-implemented method comprising: (regularly) executing, by a test operator, a reconcile function on a custom resource to emit messages comprising test configurations of the endpoint; and publishing, by the test operator, the messages onto a message queue, wherein: the message queue is polled asynchronously by workers in a worker pool, and the workers in the worker pool are to (1) translate the test configurations into tests, and (2) execute and evaluate the tests in parallel.

In Example 16, the computer-implemented method of Example 15 can optionally include: receiving a health check definition from a cluster user on an endpoint in the cluster; and creating the test operator and the custom resource based on the health check definition.

In Example 17, the computer-implemented method of Example 15 or 16 can optionally include: detecting a presence of an endpoint in a configuration of the cluster; determining a default health check definition; and creating the test operator and the custom resource based on the default health check definition.

In Example 18, the computer-implemented method of any one of Examples 15-17 can optionally include: a test configuration of the endpoint comprising a unique resource locator (URL) of the endpoint, a test on the endpoint, and an assertion corresponding to an expected result of the test.

In Example 19, the computer-implemented method of any one of Examples 15-18 can optionally include the reconcile function comprising: determining whether time elapsed from a time when a last test configuration was created is greater than a predefined period of time; and in response to the time elapsed being greater than the predefined period of time, creating a new test configuration of the endpoint.

Example 20 is a computer-implemented method for performing health checks on protected endpoints in a cluster, the computer-implemented method comprising: polling, by a worker pool having workers, a message queue having messages submitted (regularly) by one or more test operators, wherein the messages correspond to health checks on the protected endpoints in the cluster; consuming, by a worker in the worker pool, a message in the message queue; translating, by the worker, a test configuration in the message into a test command on a protected endpoint in the cluster; running, by the worker, the test command on the protected endpoint; evaluating, by the worker, a response to the test command to produce a metric; and emitting, by the worker, the metric to an endpoint monitoring system.

In Example 21, the computer-implemented method of Example 19 can optionally include running the test command comprising: obtaining, by the worker from an authentication system, a token to allow the worker to be authenticated and authorized to access the protected endpoint.

Example A is a computing system, comprising: one or more processors; and one or more storage devices; wherein the one or more storage devices store instructions, that when executed by the one or more processors, causes the computing system to perform any one of the computer-implemented methods of Examples 15-21.

Example B is an apparatus comprising means to carry out or perform any one of the computer-implemented methods of Examples 15-21.

Example C has one or more non-transitory computer-readable medium having instructions stored thereon, that when executed by one or more processors, cause the one or more processors to perform any one of the computer-implemented methods in Examples 15-21.

What is claimed is:

1. A computer-implemented system comprising:
a test operator to reconcile a custom resource to emit tests of an endpoint in a cluster, wherein the custom resource represents a state of a repetitive task scheduler;
a message queue to receive, tests of the endpoint and other endpoints in the cluster, submitted as messages, from the test operator; and
a worker pool having a plurality of workers to poll the message queue, consume the messages in the message queue, and execute and evaluate tests specified in the messages.

2. The computer-implemented system of claim 1, further comprising:
an authentication system to provide tokens to workers executing tests, wherein the tokens allow the workers to be authenticated and authorized to access the endpoints in the cluster.

3. The computer-implemented system of claim 1, wherein the test operator runs a reconcile function on the custom resource to:
determine whether time elapsed from a time when a last test was created is greater than a predefined period of time; and
in response to the time elapsed being greater than the predefined period of time, create a new test of the endpoint.

4. The computer-implemented system of claim 1, wherein the test operator runs a further reconcile function on a further custom resource to:
place a message having a configuration of a new test of the endpoint onto the message queue each time the further reconcile function is completed.

5. The computer-implemented system of claim 1, wherein a message in the message queue comprises a configuration of an endpoint test on the endpoint.

6. The computer-implemented system of claim 1, wherein the tests of the endpoint comprises pings to a unique resource locator (URL) of the endpoint in the cluster.

7. The computer-implemented system of claim 1, wherein the tests of the endpoint comprises health tests to an application programming interface in the cluster.

8. The computer-implemented system of claim 1, wherein a worker in the worker pool:
consumes a message from the message queue;
translates a configuration of an endpoint test on an endpoint in the message into an endpoint test command; and
runs the endpoint test command on the endpoint.

9. The computer-implemented system of claim 1, wherein a worker in the worker pool:
executes and evaluates a test specified in a message from the message queue;
executes a command corresponding to the test on the endpoint;
evaluates a response to the command to produce a metric; and
emits the metric to an endpoint monitoring system.

10. The computer-implemented system of claim 9, wherein the metric represents success or failure.

11. The computer-implemented system of claim 1, wherein the worker pool is set to auto-scale based on resources being consumed to execute and evaluate the tests specified in the messages.

12. The computer-implemented system of claim 1, wherein the workers in the worker pool are to operate in parallel.

13. The computer-implemented system of claim 1, wherein the workers in the worker pool polls the message queue asynchronously.

14. The computer-implemented system of claim 1, wherein the message queue is a publisher-subscriber message queue.

15. A computer-implemented method for generating health checks on endpoints in a cluster, the computer-implemented method comprising:
executing, by a test operator, a reconcile function on a custom resource to emit messages comprising test configurations of the endpoint; and
publishing, by the test operator, the messages onto a message queue, wherein:
the message queue is polled asynchronously by workers in a worker pool, and
the workers in the worker pool are to (1) translate the test configurations into tests, and (2) execute and evaluate the tests in parallel.

16. The computer-implemented method of claim 15, further comprising:
receiving a health check definition from a cluster user on an endpoint in the cluster; and
creating the test operator and the custom resource based on the health check definition.

17. The computer-implemented method of claim 15, further comprising:
detecting a presence of an endpoint in a configuration of the cluster;
determining a default health check definition; and
creating the test operator and the custom resource based on the default health check definition.

18. The computer-implemented method of claim 15, wherein a test configuration of the endpoint comprises a unique resource locator (URL) of the endpoint, a test on the endpoint, and an assertion corresponding to an expected result of the test.

19. The computer-implemented method of claim 15, wherein the reconcile function comprises:
determining whether time elapsed from a time when a last test configuration was created is greater than a predefined period of time; and
in response to the time elapsed being greater than the predefined period of time, creating a new test configuration of the endpoint.

20. A computer-implemented method for performing health checks on protected endpoints in a cluster, the computer-implemented method comprising:
polling, by a worker pool having workers, a message queue having messages submitted by one or more test operators, wherein the messages correspond to health checks on the protected endpoints in the cluster;
consuming, by a worker in the worker pool, a message in the message queue;
translating, by the worker, a test configuration in the message into a test command on a protected endpoint in the cluster;
running, by the worker, the test command on the protected endpoint;
evaluating, by the worker, a response to the test command to produce a metric; and
emitting, by the worker, the metric to an endpoint monitoring system.
